(19) United States
(12) Patent Application Publication
(10) Pub. No.: US 2021/0039350 A1
(43) Pub. Date: Feb. 11, 2021

(54) METAL PRODUCT, METAL COMPOSITE ARTICLE, AND METHODS FOR MANUFACTURING THE SAME

(71) Applicant: SHENZHENSHI YUZHAN PRECISION TECHNOLOGY CO., LTD., Shenzhen (CN)

(72) Inventors: ZHENG-QUAN WANG, Shenzhen (CN); KAR-WAI HON, New Taipei (TW)

(21) Appl. No.: 16/944,559

(22) Filed: Jul. 31, 2020

(30) Foreign Application Priority Data
Aug. 9, 2019 (CN) 201910735171.1

(51) Int. Cl. B32B 3/30; C25F 3/06; C25F 3/04; C25F 3/08; C25F 7/00; B32B 15/18; B32B 15/20; B32B 7/04; C25D 17/10

(52) U.S. Cl. CPC B32B 3/30; C25F 3/06; C25F 3/04; C25F 3/08; C25D 17/10; B32B 15/18; B32B 15/20; B32B 7/04; C25F 7/00

(57) ABSTRACT

A metal product capable of firmly combing a component of different materials with the metal to form a metal composite article includes a metal substrate. One or more surfaces of the metal substrate have a hole therein, the hole decreases in size towards an opening on the surface. A is the longest distance between any two points on a periphery of the opening. A plane of the opening is defined by the two points and a third point on the periphery of the opening. A periphery of an inner wall of the hole is defined on an intersection of the section plane and the inner wall of the hole. B is the longest distance between any two points on the periphery of the inner wall of the hole, and B is greater than A. The disclosure further provides a metal composite article and a method of manufacture.

### CROSS-REFERENCE TO RELATED APPLICATIONS

This application claims all benefits accruing under 35 U.S.C. § 119 from China Patent Application No. 201910735171.1, filed on Aug. 9, 2019, in the China Intellectual Property Administration, the entire contents of which are incorporated herein by reference.

### FIELD

The subject matter herein generally relates to metals, in particular to a metal product, a metal composite article including the metal product, and methods for manufacturing the metal product and the metal composite article.

### BACKGROUND

For the materials, used to manufacture industrial products, certain physical and chemical properties are needed, such as strength, appearance, and density. A single metal or metal alloy does not meet the growing requirements of the industrial products. Both of the characteristics of a metal and the characteristics of a material composited with the metal are retained in the metal composite articles. As a result, the metal composite articles are the new choice of the material of the industrial products.

However, in production, some problems are emerging due to the composition of two or more materials, such as poor bonding strength between these materials and difficulties of manufacturing.

### SUMMARY

In view of the above situation, it is necessary to provide a metal product capable of firmly combining a component of different materials with the metal and a method for manufacturing the metal product, and a metal composite article including the metal product and a method for manufacturing the metal composite article are also provided.

According to some embodiments, a metal product includes a metal substrate and a hole. The hole is defined on the metal substrate and includes an opening on a surface of the metal substrate. A first line is defined between a first point and a second point on a periphery of the opening, a length of the first line is a longest straight-line distance between any two points on the periphery of the opening, the length of the first line is A. A plane of the opening is defined by the first point, the second point, and a third point on the periphery of the opening. A section plane of a body of the hole is parallel to the plane of the opening. A periphery of an inner wall of the hole is defined on an intersection of the section plane and the inner wall of the hole, a second line is defined between a fourth point and a fifth point on the periphery of the inner wall of the hole, a length of the second line is a longest straight-line distance between any two points on the periphery of the inner wall of the hole, the length of the second line is B, and A<B.

According to some embodiments, a size of the hole is greater than or equal to 1 μm and less than or equal to 1000 μm.

According to some embodiments, a depth of the hole is H and 0.005 μm [symbol] H [symbol] 3000 μm.

According to some embodiments, 0.015 μm≤A≤999 μm.

According to some embodiments, 0.020 μm≤B≤1000 μm.

According to some embodiments, a material of the metal substrate is selected from a group consisting of magnesium, magnesium alloy, aluminum, aluminum alloy, titanium, titanium alloy, stainless steel, carbon steel, iron, and any combination thereof.

According to some embodiments, a metal composite includes any one of the above metal products and a component formed on the one metal product. The component includes a bonding portion defined in the hole to combine the one metal product and the component.

According to some embodiment, a material of the component is selected from a group consisting of metal, polymer, ceramic, glass, and any combination thereof.

According to some embodiment, a method for manufacturing a metal product includes: putting a metal substrate into an electrolyte which includes a film-forming agent and a film-etching agent; putting a cathode into the electrolyte; and applying a voltage to the metal substrate and the cathode to electrolyze the metal substrate to form a hole on the metal substrate to produce the metal product.

According to some embodiments, a solvent of the electrolyte is selected from a group consisting of protic solvents, the film-forming agent is selected from a group consisting of chlorine-containing compounds, the film-etching agent is selected from a group consisting of fluorine-containing compounds.

According to some embodiments, a weight content of the protic solvents is set to 100 parts, a weight content of the film-forming agent is C1, a weight content of the film-etching agent is C2, wherein 0.1% [symbol] C1 [symbol] 60% and 0.1% [symbol] C2 [symbol] 20%.

According to some embodiments, the protic solvents are at least one selected from the group consisting of water, methanol, ethanol, formic acid, and ammonia.

According to some embodiments, the cathode is made of conductive inorganic substances, a material of the conductive inorganic substances is at least one selected from a group consisting of gold, silver, copper, aluminum, zinc, tungsten, magnesium, brass, iron, platinum, calcium, molybdenum, cobalt, chromium, nickel, indium, stainless steel, tin, and graphite.

According to some embodiments, the voltage is V1 and 1V [symbol] V1 [symbol] 500V.

According to some embodiments, an electrolysis temperature of electrolysis is T, an electrolysis time is t, wherein 0° C. [symbol] T [symbol] 80° C., 0.1 seconds 8 hours.

According to some embodiments, a method for manufacturing a metal composite article includes: putting a metal substrate into an electrolyte, the electrolyte comprising a film-forming agent and a film-etching agent; putting a cathode into the electrolyte; applying a voltage to the metal substrate and the cathode to electrolyze the metal substrate to form a hole on the metal substrate to produce a metal product; providing a component material on a surface of the metal product; and curing the component material to produce the metal composite article.

In the metal product, the metal composite article, and methods for manufacturing the metal product and the metal composite article, of the present disclosure, the film-forming agent and the film-etching agent are added into the electrolyte to facilitate the formation of the hole on the metal substrate, and a longest straight-line distance A between two points on a periphery of an opening of the hole is less than a longest straight-line distance B between two points on a periphery defined on an intersection of a section plane of a body of hole and the inner wall of the hole. The opening of the hole is inwardly constricted corresponding to an interior of the hole, so that a “bottleneck” structure curving towards a center of the hole is formed, enhancing a bonding strength between the metal product and the component.

### BRIEF DESCRIPTION OF THE DRAWINGS

Implementations of the present technology will now be described, by way of embodiment, with reference to the attached figures.

FIG. 1 illustrates a cross-sectional view of a metal composite article, in accordance with some embodiments.

FIG. 2 illustrates a cross-sectional view of a metal product of the metal composite article of FIG. 1.

FIG. 3 illustrates an enlarged view of circled area III in FIG. 2.

FIG. 4 illustrates a top view of the metal product of FIG. 2.

FIG. 5 illustrates a cross-sectional view of a metal composite article, in accordance with some embodiments.

FIG. 6 illustrates a cross-sectional view of a metal composite article, in accordance with some embodiments.

FIG. 7 illustrates a method for manufacturing the metal product, in accordance with some embodiments.

FIG. 8 illustrates a method for manufacturing the metal composite article, in accordance with some embodiments.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. When a first component is referred to as “disposed to” a second component, it is intended that the first component may be directly mounted to the second component or may be indirectly mounted to a second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

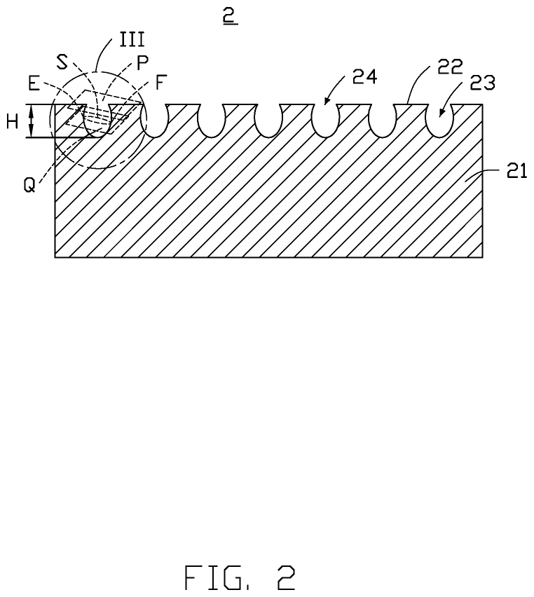

The present disclosure provides a metal product (e.g., a metal product 2 in FIG. 2) including a metal substrate and a hole defined on the metal substrate. The hole has an opening on a surface of the metal substrate. A straight line between a first point and a second point on the periphery of the opening is defined as a first line. A length of the first line is the longest straight line distance between any two points on the periphery of the opening. A plane of the opening is defined by the first point, the second point, and a differently-located third point on the periphery of the opening, a section plane of a body of the hole is parallel to the plane of the opening. A periphery of an inner wall of the hole is defined on an intersection of the section plane and the inner wall of the hole. A second line is defined between a fourth point and a fifth point on the periphery of the inner wall of the hole. A straight line between a fourth point and a fifth point on the periphery of the inner wall of the hole is defined as a second line. A length of the second line is the longest straight-line distance between any two points on the periphery of the inner wall of the hole. The length of the first line is less than the length of the second line.

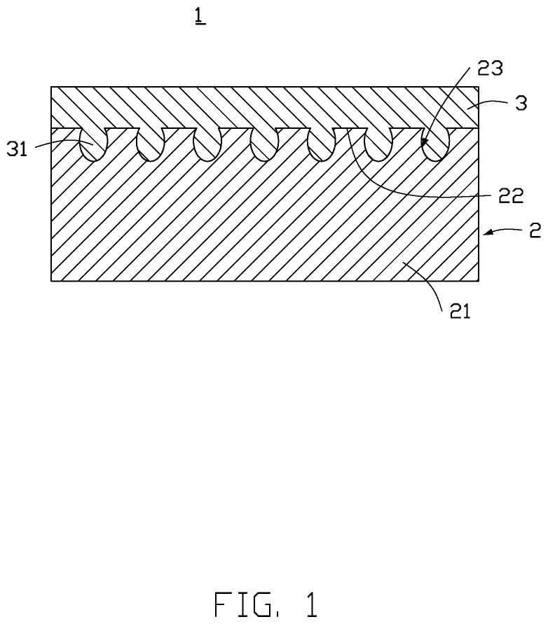

The present disclosure further provides a metal composite article (e.g., a metal composite article 1 in FIG. 1) including the metal product and a component (e.g., a component 3 in FIG. 1) formed on the metal product. The component includes a bonding portion in the hole to allow the component to be firmly combined with the metal product.

The present disclosure further provides a method for manufacturing the metal product, the method includes steps of: putting a metal substrate as an anode into an electrolyte, the electrolyte comprising a film-forming agent and a film-etching agent; putting a cathode into the electrolyte; and applying a voltage to the metal substrate and the cathode to electrolyze the metal substrate to form a hole on the metal substrate, and to produce the metal product.

The present disclosure further provides a method for manufacturing a metal composite article, the method includes steps of: providing a metal product using the above-described method for manufacturing the metal product; providing a component material on a surface of the metal product; and curing the component material to form the component to produce the metal composite article.

FIG. 1 illustrates some embodiments of the metal composite article 1, which includes the metal product 2 and the component 3 combined with the metal product 2.

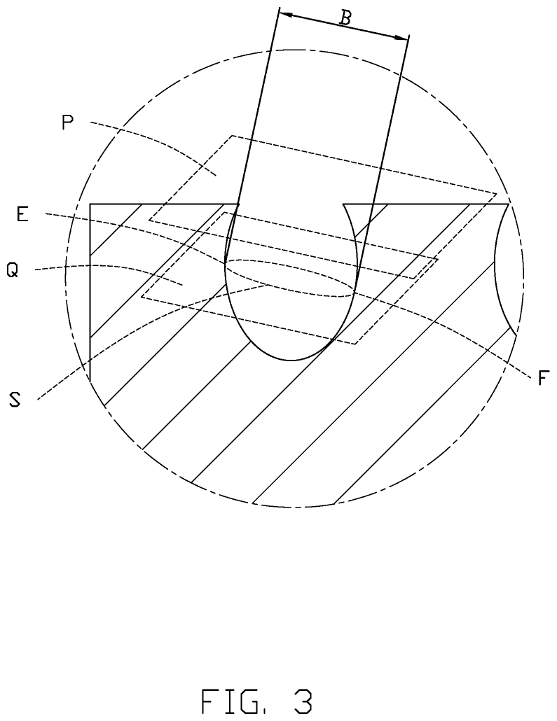

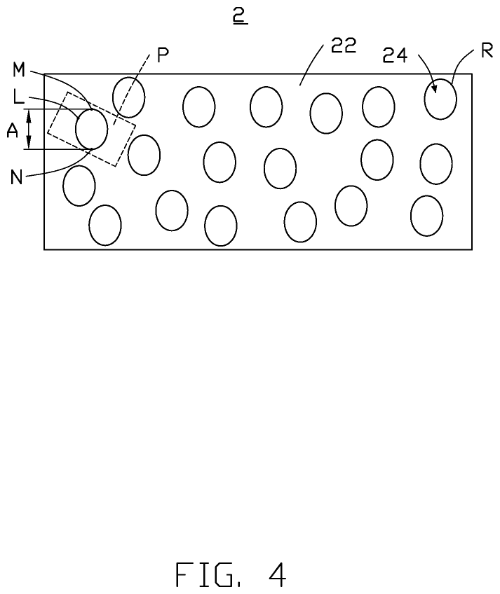

As FIGS. 2 to 4 illustrating, the metal product 2 includes a metal substrate 21 and a plurality of holes 23 defined on the metal substrate 21. Each of the holes 23 includes an opening 24 on a surface 22 of the metal substrate 21.

A periphery of the opening 24 of each of the holes 23 is defined as R. M and N are two different points on the periphery R, and a distance between the two points M and N is a length of a first line MN. The length of the first line MN is the longest straight line distance between any two points on the periphery R. The first line MN has a length of A. L is a point on the periphery R which is different from the points M and N. A plane of the opening 24 where the three points M, N, and L are located is defined as a plane P. A section plane of a body of each of the holes 23 is parallel to the plane P is defined as a plane Q. A periphery of an inner wall of each of the holes 23 formed by an intersection of the plane Q and the inner wall of each of the holes 23 is defined as S. E and F are two different points on the periphery S, and a distance between the two points E and F is a length of a second line EF. The length of the second line EF is the longest straight line distance between any two points on the periphery S. The second line EF has a length of B. A depth of each of the holes 23 is defined as H.

It should be noted that, there are more than one plane Q and periphery S, and B is the maximum value of the longest straight-line distances in all of the peripheries S, each of the longest straight-line distances is defined between two points on each periphery S. That is, if a longest straight-line distance between two points on a periphery S₁ is B₁, a longest linear distance between two points on a periphery S₂ is B₂, a longest linear distance between two points on a periphery S₃ is B₃, and a longest linear distance between two points on a periphery Sₙ, is Bₙ (n is a integer value, n>3), a value of B is the maximum value of B₁, B₂, B₃, and Bₙ.

The longest distance between two points on the periphery R is less than the longest distance between two points on the periphery S, that is A<B. A perimeter of the periphery R is less than a perimeter of the periphery S. It should be noted that, the perimeter of the periphery R is the longest perimeter of a plurality of peripheries R; the perimeter of the periphery S is the longest perimeter of a plurality of peripheries S. The opening 24 of each of the holes 23 is inwardly constricted corresponding to the interior of each of the holes 23, so that a “bottleneck” curving towards a center of each of the hole 23 is formed, enhancing a bonding strength between the metal product 2 and the component 3.

The holes 23 may be formed by an electrochemical process. Each of the holes 23 is a micron-scale hole, that is, a size of each of the holes 23 is greater than or equal to 1 μm and less than or equal to 1000 μm. The size of each of the holes 23 here may be a distance between two points on the periphery R (including the longest distance A), a distance between two points on the periphery S (including the longest distance B), or a depth H.

According to some embodiments, the longest distance A between two points on the periphery R is about 0.015 μm to 999 μm, that is 0.015 μm≤A≤999 μm. According to some embodiments, the lower limit of the longest distance A of the first line MN is one elected from the group consisting of 0.015 μm, 0.020 μm, 0.05 μm, 0.1 μm, 0.5 μm, 1 μm, 2 μm, 5 μm, 10 μm, 15 μm, 28 μm, 30 μm, 50 μm, 68 μm, 100 μm, 132 μm, 150 μm, 200 μm, 300 μm, 400 μm, 550 μm, 600 μm, 700 μm, 840 μm, 960 μm, and 999 μm; and the upper limit of the longest distance A of the first line MN is one elected from the group consisting of 0.025 μm, 0.055 μm, 0.15 μm, 0.55μm, 1.5 μm, 3 μm, 8 μm, 12 μm, 18 μm, 20 μm, 40 μm, 60 μm, 80 μm, 120 μm, 180 μm, 200 μm, 250 μm, 360 μm, 380 μm, 420 μm, 580 μm, 660 μm, 740 μm, 780 μm, 860 μm, 940 μm, 980 μm, and 999 μm. The lower limit must be less than or equal to the upper limit.

According to some embodiments, the longest distance B between two points on the periphery S is about 0.020 μm to 1000 μm, that is 0.020 μm≤B≤1000 μm. According to some embodiments, the lower limit of the longest distance B of the second line EF is one elected from the group consisting of 0.020 μm, 0.030 μm, 0.060 μm, 0.12 μm, 0.20 μm, 0.26 μm, 0.48 μm, 0.95 μm, 1.5 μm, 2.0 μm, 5.0 μm, 10 μm, 16 μm, 24 μm, 38 μm, 50 μm, 69 μm, 100 μm, 200 μm, 350 μm, 460 μm, 570 μm, 660 μm, 720 μm, 860 μm, 910 μm, and 1000 μm; and the upper limit of the longest distance B of the second line EF is one selected from the group consisting of 0.025 μm, 0.040 μm, 0.050 μm, 0.080 μm, 0.1 μm, 0.15 μm, 0.25 μm, 0.28 μm, 0.50 μm, 1.0 μm, 3.0 μm, 8.0 μm, 12 μm, 14 μm, 20 μm, 26 μm, 30 μm, 40 μm, 55 μm, 80 μm, 150 μm, 260 μm, 380 μm, 500 μm, 600 μm, 710 μm, 750 μm, 900 μm, 950 μm, and 1000 μm. The lower limit must be less than or equal to the upper limit.

According to some embodiments, the depth H of each of the holes 23 is about 0.005 μm to 3000 μm, that is 0.005 μm≤H≤3000 μm. According to some embodiments, the lower limit of the depth H of each of the holes 23 is one selected from the group consisting of 0.005 μm, 0.008 μm, 0.01 μm, 0.015 μm, 0.018 μm, 0.02 μm, 0.024 μm, 0.028 μm, 0.03 μm, 0.055 μm, 0.068 μm, 0.076 μm, 0.086 μm, 0.1 μm, 0.3 μm, 0.5 μm, 0.9 μm, 1.2 μm, 1.5 μm, 2.0 μm, 2.6 μm, 3.5 μm, 5.0 μm, 8.6 μm, 10 μm, 16 μm, 24 μm, 36 μm, 46 μm, 58 μm, 61 μm, 72 μm, 84 μm, 93 μm, 105 μm, 200 μm, 300 μm, 400 μm, 500 μm, 700 μm, 900 μm, 1000 μm, 1500 μm, 2000 μm, and 3000 μm; and the upper limit of the depth H of each of the holes 23 is one selected from the group consisting of 0.006 μm, 0.010 μm, 0.015 μm, 0.03 μm, 0.05 μm, 0.06 μm, 0.08 μm, 0.15 μm, 0.4 μm, 0.8 μm, 1.0 μm, 1.6 μm, 2.5 μm, 3.0 μm, 4.0 μm, 8.6 μm, 9.0 μm, 14 μm, 20 μm, 25 μm, 30 μm, 48 μm, 50 μm, 76 μm, 80 μm, 95 μm, 100 μm, 110 μm, 200 μm, 350 μm, 380 μm, 450 μm, 550 μm, 600 μm, 780 μm, 980 μm, 1200 μm, 1450 μm, 1800 μm, 2500 μm, 2680 μm, and 3000 μm. The lower limit must be less than or equal to the upper limit.

As FIG. 1 illustrating, the component 3 is formed on the surface 22 of the metal product 2, and portions of the component 3 are inserted into the holes 23 to be combined with the metal product 2. Specifically, the component 3 includes a plurality of bonding portions 31 inserted into the holes 23, thus the component 3 is combined with the metal product 2. According to some embodiments, each of the bonding portions 31 completely infills one of the holes 23.

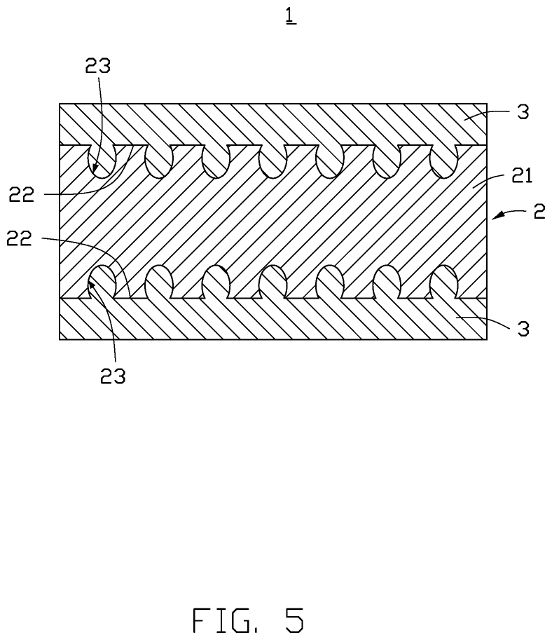

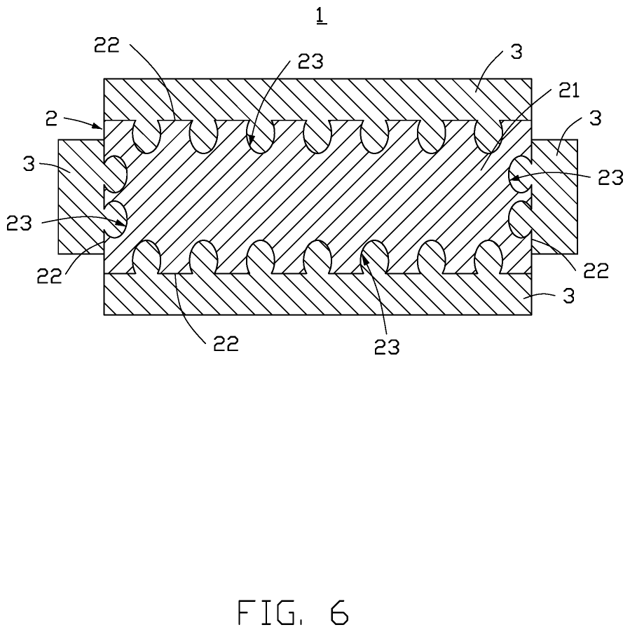

According to some embodiments, the holes 23 are defined on one surface 22 of the metal substrate 21. According to some embodiments, the holes 23 may be defined on more than one surface 22, in other words the component 3 is formed on all surfaces 22. For example, as FIG. 5 illustrating, the holes 23 may be defined on two surfaces 22 of the metal substrate 21. As FIG. 6 illustrating, the holes 23 may be defined on all four surfaces 22 of the metal substrate 21.

The metal substrate 21 may be made of a material selected from a group consisting of magnesium, magnesium alloy, aluminum, aluminum alloy, titanium, titanium alloy, stainless steel, carbon steel, iron, and any combination thereof.

The component 3 may be made of a material selected from a group consisting of metal, polymer, ceramic, glass, and any combination thereof.

In the metal product 2 and the metal composite article 1, the “bottleneck” structure of each of the holes 23 on the metal substrate 21 enhances a bonding strength between the metal product 2 and the component 3.

When the metal product 2 is made of titanium or titanium alloy, the “bottleneck” structure of each of the holes 23 also helps the metal product 2 to effectively combine with materials which have bad processing performance, such as poor fluidity. It can solve the problem that in traditional manufacturing titanium or titanium alloy products can only be combined with materials which have good processing fluidity. The “bottleneck” structure also widens a scope of applications of titanium or titanium alloys and their composites.

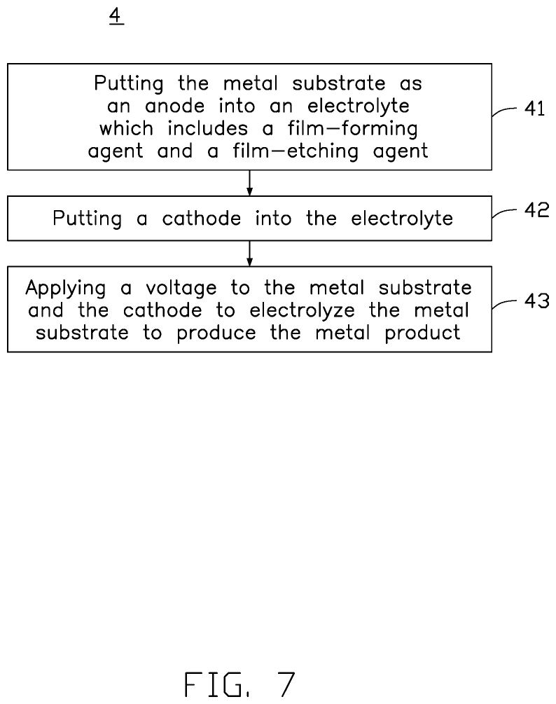

According to some embodiments, a method 4 for manufacturing the metal product 2 is provided. As FIG. 7 illustrating, the method 4 for manufacturing the metal product 2 includes steps of:

Step 41, putting the metal substrate 21 as an anode into an electrolyte which includes a film-forming agent and a film-etching agent;

Step 42, putting a cathode into the electrolyte; and

Step 43, applying a voltage to the metal substrate 21 and the cathode to electrolyze the metal substrate 21 to produce the metal product 2.

At step 41, the metal substrate 21 as the anode is put into the electrolyte, the electrolyte includes the film-forming agent and the film-etching agent.

Specifically, the electrolyte is a solution including the film-forming agent and the film-etching agent. The film-forming agent facilitates the formation of a surface passive film on the metal substrate 21 during an electrolysis process, and the film-etching agent facilitates the dissolution of the surface passive film on the metal substrate 21 during the electrolysis process. In the electrolysis process, the film-forming agent and the film-etching agent continue to facilitate the formation and dissolution of the surface passive film on the surface 22 of the metal substrate 21, thereby forming the plurality of dot-shaped holes 23 with the reduced or bottleneck opening 24 on the surface 22 of the metal substrate 21, the metal product 2 is thus formed. The reduced or bottleneck opening 24 of each of the holes 23 is illustrated in that the longest distance A between two points on the periphery R of each of the holes 23 is smaller than the longest distance B between the two points on the periphery S of each of the holes 23, that is, A<B.

The solvent of the solution is one or more selected from a group consisting of protic solvents which can donate hydrogen ions (H⁺). The solvents are selected from one or more of water, methanol, ethanol, formic acid, and ammonia.

The film-forming agent is one or more selected from a group consisting of chlorine-containing compounds which can dissociate ions of chlorine in the solution. The chlorine-containing compounds include one or more of chlorine-containing salts or chlorine-containing acids, and the chlorine-containing compounds may be inorganic substances or organic substances. According to some embodiments, the film-forming agent is composed of a halogen acid with a concentration from 1% to 5%, the halogen acid is one or more of a hydrochloric acid and a bromic acid.

The film-etching agent is one or more selected from fluorine-containing compounds which can dissociate ions of fluorine in the solution. The fluorine-containing compounds include a fluorine-containing salt or a fluorine-containing acid, and the fluorine-containing compound may be an inorganic substance or an organic substance. According to some embodiments, the film-etching agent is one or more of halogen-containing acids or salts with a concentration from 1% to 3%, the halogen-containing acids or salts is one or more of a hydrofluoric acid, an ammonium hydrogen fluoride, a potassium fluoride, and a sodium fluoride.

In the electrolytic solution, a weight content of the solvent is set to 100 parts, a weight content C₁ of the film-forming agent is about from 0.1% to 60%, that is, 0.1%≤C₁≤60%; and a weight content C₂ of the film-etching agent is about from 0.1% to 20%, that is 0.1%≤C₂≤20%.

According to some embodiments, the lower limit of the weight content C₁ of the film-forming agent is one selected from a group consisting of 0.1%, 0.02%, 0.5%, 0.8%, 1%, 1.5%, 2%, 5%, 8%, 10%, 15%, 18%, 20%, 25%, 29%, 35%, 40%, 45%, 48%, 52%, 56%, 58%, and 60%; and the upper limit of the weight content C₁ of the film-forming agent is one selected from a group consisting of 0.2%, 0.6%, 1.2%, 1.8%, 3%, 4.5%, 6%, 7.2%, 9%, 12%, 16%, 20%, 24%, 30%, 38%, 42%, 50%, 55%, 57%, and 60%. The lower limit must be less than or equal to the upper limit.

According to some embodiments, the lower limit of the weight content C₂ of the film-etching agent is one selected from a group consisting of 0.1%, 0.2%, 0.25%, 0.32%, 0.4%, 0.6%, 0.7%, 0.85%, 1%, 1.2%, 1.6%, 2%, 4%, 8%, 10%, 12%, 15%, 16%, 18%, and 20%; and the upper limit of the weight content C₂ of the film-etching agent is one selected from a group consisting of 0.15%, 0.24%, 0.3%, 0.35%, 0.5%, 0.65%, 0.8%, 0.9%, 1.1%, 1.5%, 1.8%, 3%, 6%, 11%, 14%, 19%, and 20%. The lower limit must be less than or equal to the upper limit.

In the present disclosure, controlling the contents of the film-forming agent and the film-etching agent controls the balance of the formation and dissolution of the surface passive film on the surface 22 of the metal substrate 21, so that the dot-shaped holes 23 with restricted openings 24 can be formed on the surface 22 of the metal substrate 21.

According to some embodiments, when the metal substrate 21 is made of titanium or titanium alloy, forming controllable micron-scale holes on the surface 22 of the metal substrate 21 is difficult. In the present disclosure, by controlling the contents of the film-forming agent and the film-etching agent, a plurality of controllable holes with restricted openings are formed on and evenly distributed on the surface 22 of the metal substrate 21.

At step 42, the cathode is put into the electrolyte.

The cathode is selected from a group consisting of conductive inorganic materials. The conductive inorganic materials may be made of metal or non-metal. The metal may be one or more selected from a group consisting of gold, silver, copper, aluminum, zinc, tungsten, magnesium, brass, iron, platinum, calcium, molybdenum, cobalt, chromium, nickel, indium, stainless steel, tin, etc. The non-metal may be graphite. According to some embodiments, the cathode is made of graphite or stainless steel.

At step 43, the voltage is applied to the metal substrate 21 and the cathode to apply electrolysis to the metal substrate 21.

Specifically, the metal substrate 21 is used as the anode, and a DC or AC voltage is applied on the metal substrate 21 and the cathode to perform an anodic oxidation of the metal substrate 21.

According to some embodiments, a voltage V₁ of the anodic oxidation is about in a range from 1V to 500V, that is 1V [symbol] V₁ [symbol] 500V. According to some embodiments, a lower limit of the voltage V₁ applied in the anodic oxidation is one selected from a group consisting of 2V, 5V, 10V, 15V, 20V, 24V, 30V, 35V, 40V, 45V, 48V, 50V, 55V, 59V, 60V, 65V, 70V, 75V, 80V, 85V, 90V, 95V, 100V, 110V, 120V, 130V, 140V, 150V, 160V, 170V, 180V, 200V, 220V, 240V, 250V, 280V, 300V, 330V, 350V, 370V, 400V, 420V, 450V, 470V, and 500V; and the upper limit of the voltage V₁ applied in the anodic oxidation is one selected from a group consisting of 3V, 6V, 11V, 16V, 22V, 26V, 31V, 36V, 41V, 45V, 49V, 50V, 55V, 59V, 60V, 65V, 70V, 75V, 80V, 85V, 90V, 95V, 100V, 110V, 120V, 130V, 140V, 150V, 160V, 170V, 180V, 200V, 220V, 240V, 250V, 280V, 300V, 330V, 350V, 370V, 400V, 420V, 450V, 470V, and 500V. The lower limit must be less than or equal to the upper limit.

According to some embodiments, a working temperature T of the anodic oxidation is about in a range from 0° C. to 80° C., that is 0° C≤T≤80° C. According to some embodiments, the lower limit of the working temperature T is one selected from a group consisting of 0° C., 3° C., 5° C., 8° C., 10° C., 16° C., 18° C., 20° C., 24° C., 30° C., 32° C., 38° C., 45° C., 50° C., 52° C., 55° C., 60° C., 65° C., 72° C., or 80° C.; and the upper limit of the working temperature T is 2° C., 4° C., 7° C., 9° C., 12° C., 14° C., 17° C., 21° C., 26° C., 35° C., 39° C., 42° C., 46° C., 50° C., 55° C., 64° C., 70° C., 75° C., or 80° C. The lower limit must be less than or equal to the upper limit.

According to some embodiments, a working time t of the oxidization is about in a range from 0.1 seconds to 8 hours, that is 0.1 seconds≤t≤8 hours. According to some embodiments, the lower limit of the working time t is one selected from a group consisting of 0.1 seconds, 0.5 seconds, 1 seconds, 1.5 seconds, 2 seconds, 5 seconds, 15 seconds, 25 seconds, 30 seconds, 45 seconds, 1 minutes, 5 minutes, 8 minutes, 12 minutes, 15 minutes, 20 minutes, 24 minutes, 30 minutes, 35 minutes, 40 minutes, 45 minutes, 50 minutes, 1 hours, 1.5 hours, 2 hours, 4 hours, 6 hours, and 8 hours; and the upper limit of the working time t is one selected from a group consisting of 1 seconds, 3 seconds, 8 seconds, 20 seconds, 35 seconds, 40 seconds, 50 seconds, 1.5 minutes, 3 minutes, 6 minutes, 10 minutes, 14 minutes, 18 minutes, 25 minutes, 34 minutes, 42 minutes, 55 minutes, 1.2 hours, 2.5 hours, 3 hours, 5 hours, 7 hours, 7.5 hours, and 8 hours. The lower limit must be less than or equal to the upper limit.

The above-described electrolytic process may be one or more selected from a group consisting of a single-stage electrolytic etching, a multi-stage electrolytic etching, an electrolytic etching in which the etching voltage alternately circulates in an order of large first and then small or in an order of small first and then large. The voltage V₁, the working temperature T, and the working time t can be set according to needs.

According to some embodiments, the method 4 further includes a step of degreasing the metal substrate 21 before the step 41.

The degreasing treatment can be carried out by using a conventional simple cleaning method.

According to some embodiments, the method 4 further includes a step of pickling the metal substrate 21 to remove a metal oxide layer on a surface of the metal substrate 21 before step 41.

Specifically, the metal substrate 21 is pickled with a halogen-containing acid aqueous solution such as hydrofluoric acid or hydrochloric acid. A concentration of the pickling solution may be about 1-10%, a pickling temperature may be room temperature, and a pickling time is about 5-30 seconds. According to some embodiments, the pickling solution is a mixture of hydrofluoric acid, nitric acid (68%), and a solvent, where the content of hydrofluoric acid is about 5% and the content of nitric acid (68%) is about 20%.

According to some embodiments, the method 4 further includes a step of pickling the metal substrate 21 before step 43.

The pickling solution is a mixture of hydrofluoric acid, nitric acid (68%), and a solvent, where the content of hydrofluoric acid is about 5% and the content of nitric acid (68%) is about 20%.

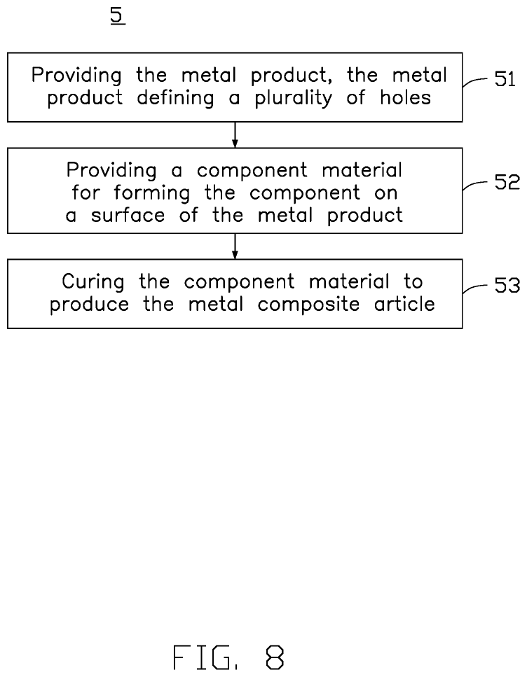

According to some embodiments, a method 5 for manufacturing the metal composite article 1 is further provided. As FIG. 8 illustrating, the method 5 for manufacturing the metal composite article 1 includes steps of:

Step 51, providing the metal product 2, the metal product 2 defining a plurality of holes;

Step 52, providing a component material for forming the component 3 on a surface of the metal product 2; and

Step 53, curing the component material to produce the metal composite article 1.

At step 51, the metal product 2 is manufactured by the method 4 for manufacturing the metal product 2.

At step 52, the component material for forming the component 3 are provided on the surface of the metal product 2.

The component material includes one or more of metal, polymer, ceramic, and glass.

At step 53, the component 3 is cured by processing the component material, to manufacture the metal composite article 1.

Specifically, when the component material is processed to form the component 3, a portion of the component material in the holes 23 is processed to form the bonding portions 31 configured to combine the component 3 with the metal product 2, to produce the metal composite article 1.

The component material can be processed by methods which are set according to properties or a status of the component material.

For example, the component material is metal and is in a particle state, the component material may be processed by a laser melting method to form the component 3.

For example, the component material is polymer, when the component material is in a liquid/solution state, the component material may be processed by evaporating a solvent of the liquid/solution to form the component 3; when the component material is in a particle state, the component material may be processed by a heat melting to form the component 3; when the component material is in a molten state, the component material may be processed by a molding method to form the component 3; when the component material is in a gas state, the component material may be processed by a gas in-situ polymerization method to from the component 3.

For example, the component material is a ceramic and is in a particle state, the component material may be processed by a sintering method or a bonding method with a bonding agent to form the component 3.

For example, the component material is glass, when component material is in a particle state, the component material may be processed by a heat melting method to form the component 3; when the component material is in a molten state, component material may be processed by a cooling method to form the component 3.

The materials and processing methods of the component material is not limited to the above examples.

In the method 4 for manufacturing the metal product 2 and the method 5 for manufacturing the metal composite article 1, the film-forming agent and the film-etching agent are added into the electrolyte and continue to facilitate the formation and dissolution of the surface passive film on the surface 22 of the metal substrate 21, thereby forming a plurality of dot-shaped holes 23 with restricted openings 24 on the surface 22 of the metal substrate 21, the holes 23 with restricted openings 24 are used as surface structures to be firmly combined with the component 3.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A metal product, comprising:
a metal substrate; and
a hole, being defined on the metal substrate and including an opening on a surface of the metal substrate;
wherein,
a first line is defined between a first point and a second point on a periphery of the opening, a length of the first line is a longest straight-line distance between any two points on the periphery of the opening, the length of the first line is A;
a plane of the opening is defined by the first point, the second point, and a third point on the periphery of the opening;
a section plane of a body of the hole is parallel to the plane of the opening;
a periphery of an inner wall of the hole is defined on an intersection of the section plane and the inner wall of the hole, a second line is defined between a fourth point and a fifth point on the periphery of the inner wall of the hole, a length of the second line is a longest straight-line distance between any two points on the periphery of the inner wall of the hole, the length of the second line is B, and A<B.

2. The metal product of claim 1, wherein a size of the hole is greater than or equal to 1 μm and less than or equal to 1000 μm.

3. The metal product of claim 1, wherein a depth of the hole is H and 0.005 μm≤H≤3000 μm.

4. The metal product of claim 1, wherein 0.015 μm≤A≤999 μm.

5. The metal product of claim 1, wherein 0.020 μm≤B≤1000 μm.

6. The metal product of claim 1, wherein a material of the metal substrate is selected from a group consisting of magnesium, magnesium alloy, aluminum, aluminum alloy, titanium, titanium alloy, stainless steel, carbon steel, iron, and any combination thereof

7. A metal composite article, comprising:
a metal product; and
a component, being formed on the metal product and including a bonding portion defined in a hole to combine the metal product and the component;
wherein,
the metal product comprising:
a metal substrate, and
the hole, being defined on the metal substrate and including an opening on a surface of the metal substrate;
a first line is defined between a first point and a second point on a periphery of the opening, a length of the first line is a longest straight-line distance between any two points on the periphery of the opening, the length of the first line is A;
a plane of the opening is defined by the first point, the second point, and a third point on the periphery of the opening;
a section plane of a body of the hole is parallel to the plane of the opening; a periphery of an inner wall of the hole is defined on an intersection of the section plane and the inner wall of the hole, a second line is defined between a fourth point and a fifth point on the periphery of the inner wall of the hole, a length of the second line is a longest straight-line distance between any two points on the periphery of the inner wall of the hole, the length of the second line is B; and A<B.

8. The metal composite article of claim 7, wherein a depth of the hole is H and 0.005 μm≤H≤3000

9. The metal composite article of claim 7, wherein 0.015 μm≤A≤999 μm.

10. The metal composite article of claim 7, wherein 0.020 μm≤B≤1000 μm.

11. The metal composite article of claim 7, wherein a material of the metal substrate is selected from a group consisting of magnesium, magnesium alloy, aluminum, aluminum alloy, titanium, titanium alloy, stainless steel, carbon steel, iron, and any combination thereof.

12. The metal composite article of claim 7, wherein a material of the component is selected from a group consisting of metal, polymer, ceramic, glass, and any combination thereof.

13. A method for manufacturing a metal product, comprising:
putting a metal substrate into an electrolyte, wherein the electrolyte includes a film-forming agent and a film-etching agent;
putting a cathode into the electrolyte; and
applying a voltage to the metal substrate and the cathode to electrolyze the metal substrate to form a hole on the metal substrate to produce the metal product.

14. The method of claim 13, wherein a solvent of the electrolyte is selected from a group consisting of protic solvents, the film-forming agent is selected from a group consisting of chlorine-containing compounds, the film-etching agent is selected from a group consisting of fluorine-containing compounds.

15. The method of claim 14, wherein a weight content of the protic solvents is set to 100 parts, a weight content of the film-forming agent is C₁, a weight content of the film-etching agent is C₂, wherein 0.1%≤C₁≤60% and 0.1%≤C₂<20%.

16. The method of claim 14, wherein the protic solvents are at least one selected from the group consisting of water, methanol, ethanol, formic acid, and ammonia.

17. The method of claim 13, wherein the cathode is made of conductive inorganic substances, a material of the conductive inorganic substances is at least one selected from a group consisting of gold, silver, copper, aluminum, zinc, tungsten, magnesium, brass, iron, platinum, calcium, molybdenum, cobalt, chromium, nickel, indium, stainless steel, tin, and graphite.

18. The method of claim 13, wherein the voltage is V₁ and 1V≤V₁<500V.

19. The method of claim 13, wherein an electrolysis temperature of electrolysis is T, an electrolysis time is t, wherein 0° C.≤T≤80° C., 0.1 seconds≤t≤8 hours.

20. A method for manufacturing a metal composite article, comprising:
putting a metal substrate into an electrolyte, the electrolyte comprising a film-forming agent and a film-etching agent;
putting a cathode into the electrolyte;
applying a voltage to the metal substrate and the cathode to electrolyze the metal substrate to form a hole on the metal substrate to produce a metal product;
providing a component material on a surface of the metal product; and
curing the component material to produce the metal composite article.
